(19) United States
(12) Patent Application Publication
(10) Pub. No.: US 2012/0004375 A1
(43) Pub. Date: Jan. 5, 2012

(54) COPOLYCARBONATES WITH IMPROVED PROPERTIES

(75) Inventors: Helmut Werner Heuer, Leverkusen (DE); Rolf Wehrmann, Krefeld (DE)

(73) Assignee: Bayer MaterialScience AG, Leverkusen (DE)

(21) Appl. No.: 13/256,978

(22) PCT Filed: Mar. 12, 2010
(86) PCT No.: PCT/EP2010/001564

§ 371 Date: Sep. 16, 2011

(30) Foreign Application Priority Data
Mar. 18, 2009 (DE) 10 2009 013 643.6

(51) Int. Cl. C08L 69/00; C08G 64/24; C08G 64/16

(52) U.S. Cl. 525/469; 528/204

(57) ABSTRACT

The present invention relates to copolycarbonates with improved surface hardness, processes for producing the same, and use of the same for producing blends, moldings, and extrudates, foil (layers), foil laminates, and cards.

The present invention relates to moldings and extrudates, foils, and laminates, with improved mechanical properties, and with good heat resistance and chemicals resistance, and also to processes for producing the same and to the use of the same, in particular in the electrical/electronics (E/E) sector and in medical technology.

Aromatic polycarbonates are engineering thermoplastics. They feature a combination of the following technologically important properties: transparency, heat resistance, and toughness.

JP-A 09-183838 describes polycarbonates using the melt process, where the aromatic dihydroxy components comprise a proportion of at least 80 mol % of a mixture made of 1,1-bis(4-hydroxyphenyl)-3,3,5-trimethylcyclohexane (TMC) and 2,2-bis(3-methyl-4-hydroxyphenyl)propane. The polycarbonates are said to have particularly good suitability for optical applications (disks, lenses, cards) because of their low birefringence.

JP-A 09-204053 describes polycarbonates comprising 1,1-bis(4-hydroxyphenyl)-3,3,5-trimethylcyclohexane and 2,2-bis(3-methyl-4-hydroxyphenyl)propane as binding component in an organic photoreceptor layer. However, these are applications which use exclusively mixtures made of copolycarbonates which can comprise at most 50% of TMC, with hydrazone derivatives. This application does not relate to said applications.

WO 2008/008599 A2 describes the use of polycarbonates which can comprise 2,2-bis(3-methyl-4-hydroxyphenyl)propane and/or 1,1-bis(3-methyl-4-hydroxyphenyl)cyclohexane, for producing flame-retardant items which have good scratch resistance.

WO 2003/005354 A1 describes polycarbonates which can comprise 1,1-bis(3-methyl-4-hydroxyphenyl)-3,3,5-trimethylcyclohexane. These are said to have particular suitability as materials for data carriers, because of their good damping properties.

WO 2007/008390 A2 describes polycarbonates which comprise 1,1-bis(3-methyl-4-hydroxyphenyl)cyclohexane and optionally 2,2-bis(3-methyl-4-hydroxyphenyepropane. Windows and other articles made from said copolycarbonate are disclosed as having good scratch resistance. Good resistance to ammonia is also disclosed.

JP-A 10-138649 describes homo- and copolycarbonates comprising various diphenols, where these are suitable for nonblocking sheets in thermal transfer applications. That document does not describe the specific combinations mentioned in the present application or the advantageous properties of these.

The present invention achieves the object of providing copolycarbonates which are composed of simple, unbridged monomer units and which, in comparison with known copolycarbonates composed of simple, unbridged monomer units, have an improved combination of properties in relation to surface hardness, scratch resistance, heat resistance, and chemicals resistance. The present invention also achieves the objects of providing processes for producing such copolycarbonates and of providing such copolycarbonates for applications which place particular requirements on surface stability, and/or on chemicals resistance, and/or on heat resistance, without any need to apply an additional protective layer. Particular applications and products that may be mentioned here are those for medical technology, for the electrical/electronics sector (e.g. “soft keys”), lenses (e.g. infrared lenses), screen/display covers, and frames, and housing parts, and also foils, foil laminates, and cards.

Surprisingly, it has been found that copolycarbonates solve this problem through the use of a combination of respectively at least one compound of the general formula (1a) and (1b)

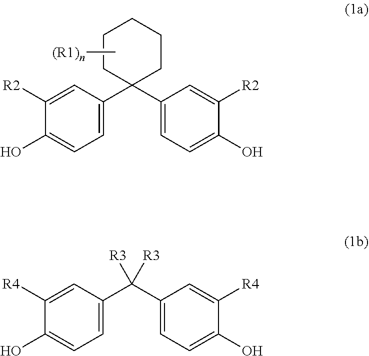

in which R1 are mutually independently C₁-C₄-alkyl, preferably methyl, ethyl, n-propyl, isopropyl, tert-butyl, and very particularly preferably methyl,

n is 1, 2, or 3,

and R2 are mutually independently H, linear or branched C₁-C₁₀-alkyl, preferably linear or branched C₁-C₆-alkyl, particularly preferably linear or branched C₁-C₄-alkyl, in particular methyl, ethyl, n-propyl, isopropyl, tert-butyl, and very particularly preferably methyl,

and in which R3 are mutually independently linear or branched C₁-C₁₀-alkyl, preferably linear or branched C₁-C₆-alkyl, particularly preferably linear or branched C₁-C₄-alkyl, very particularly preferably C₁-alkyl, and

the R4 moieties are mutually independently H, linear or branched C₁-C₁₀-alkyl, preferably linear or branched C₁-C₆-alkyl, particularly preferably linear or branched C₁-C₄-alkyl, in particular methyl, ethyl, n-propyl, isopropyl, tert-butyl, and very particularly preferably H or methyl.

The copolycarbonates of the invention therefore comprise diphenolate monomer units derived from
a) at least one compound from the group consisting of the compounds having the general formula

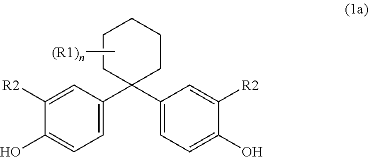

in which the R1 moieties are mutually independently C₁-C₄-alkyl, preferably methyl, ethyl, n-propyl, isopropyl, tert-butyl, and very particularly preferably methyl,
n is 1, 2, or 3,
and the R2 moieties are mutually independently H, linear or branched C₁-Cₘ-alkyl, preferably linear or branched C₁-C₆-alkyl, particularly preferably linear or branched C₁-C₄-alkyl, in particular methyl, ethyl, n-propyl, isopropyl, tert-butyl, and very particularly preferably methyl, and
b) at least one compound from the group consisting of the compounds having the general formula

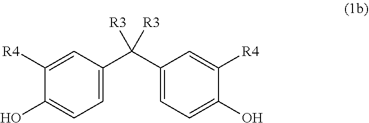

in which the R3 moieties are mutually independently linear or branched C₁-C₁₀-alkyl, preferably linear or branched C₁-C₆-alkyl, particularly preferably linear or branched C₁-C₄-alkyl, very particularly preferably C₁-alkyl, and
the R4 moieties are mutually independently H, linear or branched C₁-C₁₀-alkyl, preferably linear or branched C₁-C₆-alkyl, particularly preferably linear or branched C₁-C₄-alkyl, in particular methyl, ethyl, n-propyl, isopropyl, tert-butyl, and very particularly preferably H or methyl.

It is particularly preferable that the copolycarbonates comprise combinations of one or more compounds of the general formulae (2a) and (2d), (2a) and (2b), or else (2c) and (2b),

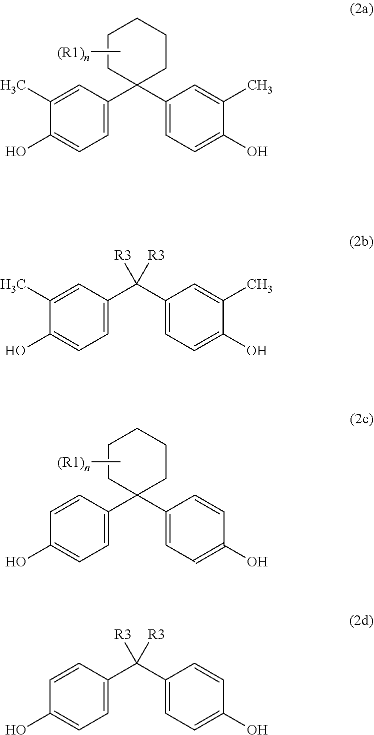

in which n, R1, and R3 are the moieties described under the formulae (1).

Among the compounds (2a), (2b), (2c), and (2d) here, very particular preference is given to the compounds which are described by the formulae (3a), (3b), (3c) and (3d).

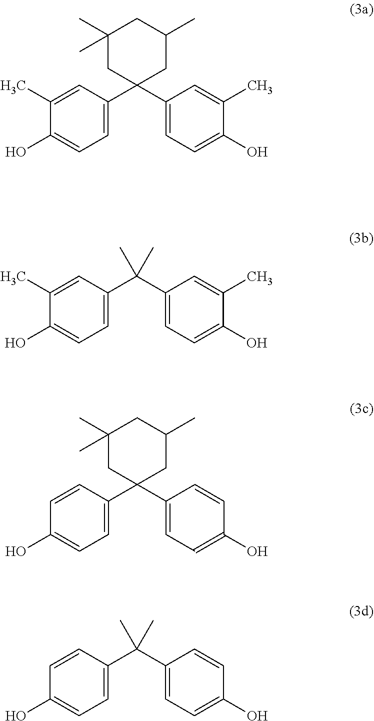

The present invention therefore provides copolycarbonates comprising a combination of monomer units (4a) and (4b) derived from a combination of at least one compound of the general formula (1a) and of at least one compound of the general formula (1b),

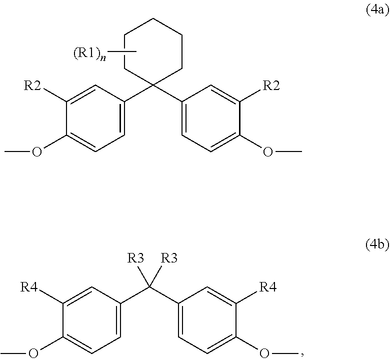

in which the R1 moieties are mutually independently C₁-C₄-alkyl, preferably methyl, ethyl, n-propyl, isopropyl, tert-butyl, and very particularly preferably methyl,

n is 1, 2 or 3,

and the R2 moieties are mutually independently H, linear or branched C₁-C₁₀-alkyl, preferably linear or branched C₁-C₆-alkyl, particularly preferably linear or branched C₁-C₄-alkyl, in particular methyl, ethyl, n-propyl, isopropyl, tert-butyl, and very particularly preferably methyl,

and the R3 moieties are mutually independently linear or branched C₁-C₁₀-alkyl, preferably linear or branched C₁-C₆-alkyl, particularly preferably linear or branched C₁-C₄-alkyl, very particularly preferably C₁-alkyl, and

the R4 moieties are mutually independently H, linear or branched C₁-C₁₀-alkyl, preferably linear or branched C₁-C₆-alkyl, particularly preferably linear or branched C₁-C₄-alkyl, in particular methyl, ethyl, n-propyl, isopropyl, tert-butyl, and very particularly preferably H or methyl.

The monomer units are introduced by way of the corresponding diphenols of the general formulae (1a) and (1b).

It is particularly preferable that the monomer units derive from diphenols of the general formula (2a)-(2d).

Particular preference is given here to the respective combination of the following compounds: (2a) with (2b), (2b) with (2c), and (2a) with (2c). In these compounds it is very particularly preferable that n=3, and R1 and R3=methyl.

This gives very particularly preferred copolymers of the invention, comprising combinations of the following compounds:
1,1-bis(3-methyl-4-hydroxyphenyl)-3,3,5-trimethylcyclohexane (3a) and 2,2-bis(4-hydroxyphenyl)propane (3d) (bisphenol A),
1,1-bis(-3-methyl-4-hydroxyphenyl)-3,3,5-trimethylcyclohexane (3a) and 2,2-bis(3-methyl-4-hydroxyphenyl)propane (3b) or
1,1-bis(4-hydroxyphenyl)-3,3,5-trimethylcyclohexane (3c) (bisphenol TMC) and 2,2-bis(3-methyl-4-hydroxyphenyl)propane (3b).

The total content of the diphenolic compounds (I a) of the invention in the copolycarbonate is from 0.1 to 70 mol %, preferably from 1 to 60 mol %, particularly preferably from 5 to 50 mol %, and very particularly preferably from 5 to 35 mol % (based on the total number of moles of diphenols used of the general formulae (1a) and (1b)). In other preferred embodiments, the total content of the compounds (1a) is from 40 to 90 mol %, from 45 to 80 mol %, from 50 to 75 mol %, and from 55 to 75 mol %, based on the total number of moles of diphenols used of the general formulae (1a) and (1b).

The copolycarbonates can take the form of block copolycarbonates and of random copolycarbonates. The ratio of the frequency of the diphenolate monomer units in the copolycarbonate here is calculated from the molar ratio of the diphenols used.

The polycarbonates or copolycarbonates can also have branching. To this end, certain small amounts, preferably amounts of from 0.05 to 5 mol %, particularly preferably from 0.1 to 3 mol %, very particularly preferably from 0.1 to 2 mol %, based on the number of moles of diphenols used, of trifunctional compounds are used as what are known as branching agents, examples being isatinbiscresol (IBc) or phloroglucinol, 4,6-dimethyl-2,4,6-tri(4-hydroxyphenyl)hept-2-ene; 4,6-dimethyl-2,4,6-tri(4-hydroxyphenyl)heptane; 1,3,5-tri(4-hydroxyphenyl)benzene; 1,1,1-tri(4-hydroxyphenyl)ethane (THPE); tri(4-hydroxyphenyl)phenylmethane; 2,2-bis[4,4-bis(4-hydroxyphenyl)-cyclohexyl]propane; 2,4-bis(4-hydroxyphenylisopropyl)phenol; 2,6-bis(2-hydroxy-5′-methylbenzyl)-4-methylphenol; 2-(4-hydroxyphenyl)-2-(2,4-dihydroxyphenyl)propane; hexa(4-(4-hydroxyphenylisopropyl)phenyl)orthoterephthalate; tetra(4-hydroxyphenyl)methane; tetra(4-(4-hydroxyphenylisopropyl)phenoxy)methane; tris(4-hydroxyphenyl)-1,3,5-triisopropylbenzene; 2,4-dihydroxybenzoic acid; trimesic acid; cyanuric chloride; 3,3-bis(3-methyl-4-hydroxyphenyl)-2-oxo-2,3-dihydroindole; 1,4-bis(4′,4″-dihydroxytriphenyl)methyl)benzene, and in particular 1,1,1-tri(4-hydroxyphenyl)ethane and bis(3-methyl-4-hydroxyphenyl)-2-oxo-2,3-dihydroindole. It is preferable that the branching agents used comprise isatinbiscresol, or else 1,1,1-tri(4-hydroxyphenyl)ethane and bis(3-methyl-4-hydroxyphenyl)-2-oxo-2,3-dihydroindole.

The use of these branching agents gives branched structures. The resultant long-chain branching mostly leads to more pseudoplasticity in the rheological properties of the resultant polycarbonates in comparison with linear types.

The copolycarbonates of the invention can also comprise from 2 to 20 proportions of diphenols of the formula (5a)

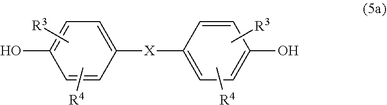

in which
R³ and R⁴ are mutually independently hydrogen, C₁-C₁₈-alkyl, C₁-C₁₈-alkoxy, halogen, or respectively optionally substituted aryl or aralkyl, and
   X is a single bond, —SO₂—, —CO—, —O—, —S—, C₁- to C₆-alkylene, C₂- to C₅-alkylidene or C₅- to C₆-cycloalkylidene, which can have substitution by C₁- to C₆-alkyl, or X is C₆-C₁₂-arylene which can optionally have been condensed with further aromatic rings comprising heteroatoms.

It is particularly preferable that the structure (5a) is 2,2-bis(4-hydroxyphenyl)propane (bisphenol A or BPA).

To obtain high-molecular-weight polycarbonates by the interfacial process, the alkali metal salts of diphenols are reacted with phosgene in a two-phase mixture. The molecular weight can be controlled via the amount of monophenols, e.g. phenol or tert-butylphenol. These reactions produce practically exclusively linear polymers. This can be demonstrated via terminal-group analysis. Specific use of what are known as branching agents here, generally polyhydroxylated compounds, also gives branched polycarbonates.

The present invention further provides a process for producing the copolycarbonates of the invention comprising diphenolate units derived from diphenols of the formulae (1), (2), and (3), characterized in that the diphenols and optionally branching agents are dissolved in aqueous alkaline solution and are reacted with a carbonate source, such as phosgene, in a two-phase mixture made of an aqueous alkaline solution, of an organic solvent, and of a catalyst, preferably an amine compound, where the carbonate source may optionally have been dissolved in a solvent. The reaction can also be conducted in a plurality of stages.

Processes of this type for producing polycarbonate are known in principle as two-phase interfacial processes for example from H. Schnell, Chemistry and Physics of Polycarbonates, Polymer Reviews, vol. 9, Interscience Publishers, New York 1964 pp. 33 ff., and from Polymer Reviews, vol. 10, “Condensation Polymers by Interfacial and Solution Methods”, Paul W. Morgan, Interscience Publishers, New York 1965, chapter VIII, p. 325, and the fundamental conditions are therefore familiar to the person skilled in the art.

The concentration of the diphenols in the aqueous alkaline solution here is from 2 to 25% by weight, preferably from 2 to 20% by weight, particularly preferably from 2 to 18% by weight, and very particularly preferably from 3 to 15% by weight. The aqueous alkaline solution is composed of water in which hydroxides of alkali metals or alkaline earth metals have been dissolved. Sodium hydroxide and potassium hydroxide are preferred.

When phosgene is used as carbonate source, the ratio by volume of aqueous alkaline solution to organic solvent is from 5:95 to 95:5, preferably from 20:80 to 80:20, particularly preferably from 30:70 to 70:30, and very particularly preferably from 40:60 to 60:40. The molar ratio of diphenol to phosgene is smaller than 1:10, preferably smaller than 1:6, particularly preferably smaller than 1:4, and very particularly preferably smaller than 1:3. The concentration of the branched polycarbonates and copolycarbonates of the invention in the organic phase is from 1.0 to 25% by weight, preferably from 2 to 20% by weight, particularly preferably from 2 to 18% by weight, and very particularly preferably from 3 to 15% by weight.

The concentration of the amine compound, based on the amount of diphenol used, is from 0.1 to 10 mol %, preferably from 0.2 to 8 mol %, particularly preferably from 0.3 to 6 mol %, and very particularly preferably from 0.4 to 5 mol %.

The term diphenols means diphenol mixtures selected from the abovementioned compounds, with proportions of the abovementioned branching agents. The carbonate source is phosgene, diphosgene, or triphosgene, preferably phosgene. When phosgene is used it is optionally possible to omit a solvent and to introduce the phosgene directly into the reaction mixture.

Catalysts that can be used are tertiary amines, such as triethylamine or N-alkylpiperidines. Suitable catalysts are trialkylamines and 4-(dimethylamino)pyridine. Particularly suitable compounds are triethylamine, tripropylamine, triisopropylamine, tributylamine, triisobutylamine, N-methylpiperidine, N-ethylpiperidine, and N-propylpiperidine.

Organic solvents that can be used are halogenated hydrocarbons, such as methylene chloride, chlorobenzene, dichlorobenzene, trichlorobenzene, or a mixture thereof, or aromatic hydrocarbons, e.g. toluene or xylenes. The reaction temperature can be from −5° C. to 100° C., preferably from 0° C. to 80° C., particularly preferably from 10° C. to 70° C., and very particularly preferably from 10° C. to 60° C.

It is also possible to produce the polycarbonates by the melt transesterification process, in which the diphenols are reacted in the melt with diaryl carbonates, in most cases diphenyl carbonate, in the presence of catalysts, such as alkali metal salts, ammonium compounds, or phosphonium compounds.

The melt transesterification process is described by way of example in Encyclopedia of Polymer Science, vol. 10 (1969), Chemistry and Physics of Polycarbonates, Polymer Reviews, H. Schnell, vol. 9, John Wiley and Sons, Inc. (1964), and also in DE-C 10 31 512.

In the melt transesterification process, the aromatic dihydroxy compounds described above for the interfacial process are transesterified in the melt with carbonic diesters with the aid of suitable catalysts and optionally of further additives.

For the purposes of the invention, carbonic diesters are those of the formulae (6) and (7)

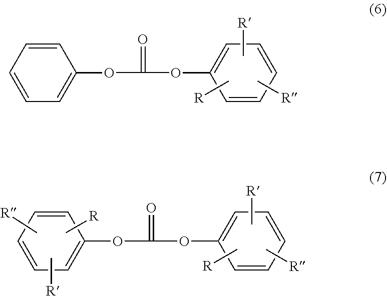

where

R, R′, and R″ can be mutually independently H, optionally branched C₁-C₃₄-alkyl/cycloalkyl, C₇-C₃₄-alkaryl, or C₆-C₃₄-aryl,

examples being

diphenyl carbonate,

butylphenyl phenyl carbonate, dibutylphenyl carbonate,

isobutylphenyl phenyl carbonate, diisobutylphenyl carbonate,

tert-butylphenyl phenyl carbonate, di-tert-butylphenyl carbonate,

n-pentylphenyl phenyl carbonate, di(n-pentylphenyl)carbonate,

n-hexylphenyl phenyl carbonate, di(n-hexylphenyl)carbonate,

cyclohexylphenyl phenyl carbonate, dicyclohexylphenyl carbonate,

phenylphenol phenyl carbonate, diphenylphenol carbonate,

isooctylphenyl phenyl carbonate, diisooctylphenyl carbonate,

n-nonylphenyl phenyl carbonate, di(n-nonylphenyl)carbonate,

cumylphenyl phenyl carbonate, dicumylphenyl carbonate,

naphthylphenyl phenyl carbonate, dinaphthyl phenyl carbonate,

di-tert-butylphenyl phenyl carbonate, di(di-tert-butylphenyl)carbonate,

dicumylphenyl phenyl carbonate, di(dicumylphenyl) carbonate,

4-phenoxyphenyl phenyl carbonate, di(4-phenoxyphenyl)carbonate,

3-pentadecylphenyl phenyl carbonate, di(3-pentadecylphenyl)carbonate,

tritylphenyl phenyl carbonate, ditritylphenyl carbonate,

preferably

diphenyl carbonate,

tert-butylphenyl phenyl carbonate, di-tert-butylphenyl carbonate,

phenylphenol phenyl carbonate, diphenylphenol carbonate,

cumylphenyl phenyl carbonate, dicumylphenyl carbonate,

particularly preferably diphenyl carbonate.

It is also possible to use a mixture of the carbonic diesters mentioned.

The proportion of carbonic ester is from 100 to 130 mol %, preferably from 103 to 120 mol %, particularly preferably from 103 to 109 mol %, based on the dihydroxy compound.

For the purposes of the invention, catalysts used in a melt transesterification process are, as described in the literature mentioned, basic catalysts, for example alkali metal hydroxides and alkaline earth metal hydroxides and alkali metal oxides and alkaline earth metal oxides, and also ammonium salts or phosphonium salts, hereinafter termed onium salts. Preference is given here to onium salts, and particularly to phosphonium salts. For the purposes of the invention, phosphonium salts are salts of the following general formula (8)

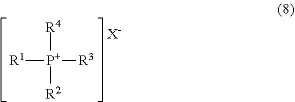

where

R¹⁻⁴ can be identical or different C₁-C₁₀-alkyl moieties, C₆-C₁₀-aryl moieties, C₇-C₁₀-aralkyl moieties, or C₅-C₆-cycloalkyl moieties, preferably methyl, or C₆-C₁₄-aryl moieties, particularly preferably methyl or phenyl, and

X⁻ can be an anion, such as hydroxide, sulfate, hydrogen sulfate, hydrogen carbonate, carbonate, a halide, preferably chloride, or an alcoholate of the formula OR, where R can be C₆-C₁₄-aryl or C₇-C₁₂-aralkyl, preferably phenyl. Preferred catalysts are

tetraphenylphosphonium chloride,

tetraphenylphosphonium hydroxide,

tetraphenylphosphonium phenolate,

and particularly tetraphenylphosphonium phenolate.

Preferred amounts used of the catalysts are from 10⁻⁸ to 10⁻³ mol, particularly from 10⁻⁷ to 10⁻⁴ mol, based on one mole of diphenol.

Other catalysts can be used alone or optionally in addition to the onium salt, in order to increase the polymerization rate. Among these are salts of alkali metals and of alkaline earth metals, e.g. hydroxides, alkoxides, and aryl oxides of lithium, sodium, and potassium, preferably the hydroxide, alkoxide, or aryl oxide salts of sodium. Most preference is given to sodium hydroxide and sodium phenolate. The amounts of the cocatalyst can be in the range from 1 to 200 ppb, preferably from 5 to 150 ppb, and most preferably from 10 to 125 ppb, in each case calculated as sodium.

The transesterification reaction of the aromatic dihydroxy compound and of the carbonic diester in the melt is preferably carried out in two stages. In the first stage, the melting of the aromatic dihydroxy compound and of the carbonic diester takes place at temperatures from 80 to 250° C., preferably from 100 to 230° C., particularly preferably from 120 to 190° C., under atmospheric pressure, in from 0 to 5 hours, preferably from 0.25 to 3 hours. After addition of the catalyst, the oligocarbonate is produced from the aromatic dihydroxy compound and from the carbonic diester via application of vacuum (extending to 2 mm of Hg) and increase of temperature (extending as far as 260° C.), through removal of the monophenol by distillation. Most of the vapors produced by the process occur during this phase. The weight-average molar mass M_{w} of the resultant oligocarbonate is in the range from 2000 g/mol to 18 000 g/mol, preferably from 4000 g/mol to 15 000 g/mol (determined via measurement of the relative solution viscosity in dichloromethane or in a mixture of equal amounts by weight of phenol/o-dichlorobenzene, with calibration by light scattering).

In the second stage, the polycarbonate is produced in the polycondensation process through a further increase in temperature to from 250 to 320° C., preferably from 270 to 295° C., using a pressure of <2 mm of Hg. The remainder of vapors produced by the process is removed during this phase.

It is also possible to use the catalysts in a combination (of two or more) with one another.

When alkali metal/alkaline earth metal catalysts are used it can be advantageous to add the alkali metal/alkaline earth metal catalysts at a later juncture (e.g. after synthesis of the oligocarbonate, during the polycondensation process in the second stage).

For the purposes of the process of the invention, the reaction of the aromatic dihydroxy compound and of the carbonic diester to give the polycarbonate can be carried out batchwise or preferably continuously, for example in stirred tanks, thin-film evaporators, falling-film evaporators, stirred-tank cascades, extruders, kneaders, simple disk reactors, and high-viscosity disk reactors.

Use of polyfunctional compounds can produce branched poly- or copolycarbonates by analogy with the interfacial process.

The relative solution viscosity of the copolycarbonates of the invention, determined to DIN 51562, is preferably in the range from 1.15 to 1.35.

Preference, particular preference, or very particular preference is given to embodiments which use the parameters, compounds definitions, and explanations mentioned under the heading of preferred, particularly preferred, or very particularly preferred, or with preference, etc.

However, the definitions, parameters, compounds, and explanations listed in general terms in the description or listed in preferred ranges can also be combined as desired with one another, i.e. combining the respective ranges and preferred ranges.

The copolycarbonates of the invention can be worked up in a known manner and processed to give any desired moldings, for example through extrusion, injection molding, or extrusion blowmolding.

The copolycarbonates of the invention can also receive admixtures of other aromatic polycarbonates and/or other aromatic polyester carbonates, and/or other aromatic polyesters, in a known manner, for example through compounding.

The copolycarbonates of the invention can also receive admixtures of the conventional amounts of the additives conventional for these thermoplastics, e.g. mold-release agents or gamma-radiation stabilizers. They can also comprise content of another plastic (blends).

The copolycarbonates of the invention, optionally in a blend with other thermoplastics and/or with conventional additives, can be processed to give any desired moldings/extrudates, wherever previously known polycarbonates, polyester carbonates, and polyesters are used. Their property profile gives them particular suitability as materials for the injection molding of relatively large moldings, for example automobile windshields. However, low water absorption and the attendant improved dimensional stability also gives particular suitability as substrate materials for optical data storage systems, e.g. CD, CD-R, DVD, DVD-R, Blu-ray Disc, or Advanced Optical Disc (AOD), but can also by way of example be used in the form of foils in the electrical sector, in the form of moldings in vehicle construction, and in the form of panels for coverings in the safety/security sector. Other possible applications of the polycarbonates of the invention are:
Safety/security panels which are known to be required in many regions of buildings, of vehicles and of aircraft, and also shields on helmets.
Production of foils, in particular ski foils.
Production of blown products (see by way of example U.S. Pat. No. 2,964,794), an example being water bottles holding from 1 to 5 gallons.
Production of translucent sheets, in particular of hollow-chamber panels, for example for the protective covering of buildings, for example of railway stations or of greenhouses, and of lighting systems.
Production of optical data storage devices.
Production of traffic-signal housings or of traffic signs.
Production of foams (see by way of example DE-B 1 031 507).
Production of filaments and wires (see by way of example DE-B 1 137 167 and DE-A 1 785 137).
Translucent plastics comprising glass fibers for lighting applications (see by way of example DE-A 1 554 020).
Translucent plastics comprising barium sulfate, titanium dioxide and/or zirconium oxide or, respectively, organic polymeric acrylate rubbers (EP-A 634 445, EP-A 269 324), for the production of translucent and light-scattering moldings.
Production of small precision-engineered injection-molded parts, for example lense holders. Polycarbonates comprising glass fibers are used for this purpose and, if appropriate, also comprise from about 1 to 10% by weight of MoS₂, based on total weight.
Production of optical device components, in particular lenses for photographic cameras and for film cameras (see by way of example DE-A 2 701 173).
Light transmitters, in particular optical conductor cables (see by way of example EP-A 0 089 801).
Electrically insulating materials for electrical conductors and for plug housings, and also plug connectors.
Production of mobile telephone casings with improved resistance to perfume, aftershave and sweat.
Network interface devices.
Production of lights, e.g. headlamps, diffusor sheets, or inner lenses, and also linear luminaires.
Food-and-drink applications, e.g. bottles, tableware, and chocolate molds.
Applications in the automobile sector, where contact with fuels and lubricants can occur, examples being bumpers, optionally in the form of suitable blends with ABS or with suitable rubbers.
Sports items, e.g. slalom poles or ski-boot clips.
Household items, e.g. kitchen sink units and mailbox housings.
Housings such as electrical distribution cabinets.
Casings for electric toothbrushes and hair-dryer casings.
Transparent washing machines—portholes with improved resistance to the washing solution.
Protective eyewear, visors, or corrective spectacles.
Lamp covers for kitchen equipment with improved resistance to kitchen fume, particularly oil fume.
Packaging foils for pharmaceutical products.
Chip boxes and chip carriers.
Other applications, e.g. animal cages, or feed doors for animal stalls.
Safety helmets.

Particular preference is given to applications of the copolycarbonates of the invention in medical technology, in particular products for
medical applications, e.g. oxygenators, dialyzers (hollow-fiber dialyzers), dialysis modules, or hemofilters (transparent housing parts of these “artificial kidneys”)
cardiotomy reservoirs (for use during the operation to collect blood removed by suction)
blood heat exchangers
hose connectors
3-way valves
blood filters
injection systems (for direct contact with blood and with intravenously introduced liquids)
inhalers (for treating asthma and respiratory tract)
centrifuge systems in medical technology (blood centrifuge in combination with a cardiotomy reservoir)
ampoules (e.g. for needleless injection system)
foils, for example for use in blood sugar measurement equipment
patient terminal (e.g. call systems for care personnel)
operation boxes for scalpels in surgery
suction-removal equipment for emergency medicine
lamp housings for baby incubators
respiratory aid, e.g. bag valve mask for emergency medical services
laparoscope for microsurgery
packaging foils for pharmaceutical products.

Particular preference is likewise given to products for electrical/electronic (E/E) applications, e.g.
soft keys, keypads
touchscreen applications
housings, housing parts, and frames
lenses (e.g. infrared lenses)
screen/display covers
diffusor sheets.

One preferred application sector here is portable multimedia devices, such as MP3 players, mobile telephones, computers, and digital cameras, and also flat screens.

Very particular preference is also given to foils and foil laminates, and also to foils and foil laminates comprising coextruded or laminate layers made of the polymers of the invention, and to use of these in the abovementioned applications.

The examples below are intended to illustrate the invention, but not to restrict the same.

### EXAMPLES

### Example 1

### Synthesis of the monomer unit 1,1-bis(-3-methyl-4-hydroxyphenyl)-3,3,5-trimethylcyclohexane (3a) (HCl process)

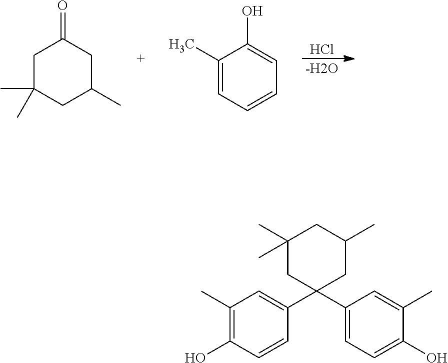

An amount of 42.07 g (0.3 mol) of 3,3,5-trimethylcyclohexanone, 324.42 g (3.0 mol) of freshly distilled o-cresol of purity >99%, and 0.812 g (0.004 mol) of dodecyl mercaptan as cocatalyst form an initial charge at about 36° C. under nitrogen in a round-bottomed multinecked flask.

10 g of hydrogen chloride gas are then introduced from the gas cylinder into the colorless transparent solution within a period of 30 minutes.

The reaction is slightly exothermic and heats the entire solution to about 42° C.

After the introduction has ended, the mixture is heated to 60° C. within a period of 10 minutes, and is kept at said temperature for 25 minutes.

After the reaction has ended, the excess HCl is drawn off at 80° C. in the vacuum provided by a water pump. The residue is then subjected to careful incipient high-vacuum distillation, in order to remove the excess of o-cresol and catalyst.

The residue is taken up in methylene chloride, washed repeatedly with water, and dried. This gives, as residue, a white solid which can be phosgenated without further purification (see example 4).

### Example 2 (Comparative Example)

### Synthesis of a copolycarbonate made of bisphenol A (BPA) and bisphenol TMC

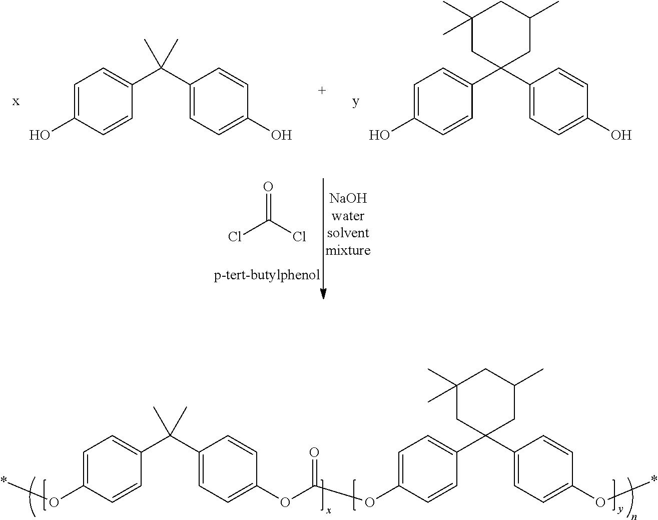

Methylene chloride (568.4 ml) is added to a nitrogen-inertized solution of 47.94 g (0.21 mol) of bisphenol A (BPA), 27.94 g (0.09 mol) of bisphenol TMC, 1.352 g (0.009 mol, 3.0 mol % based on bisphenols) of p-tert-butylphenol (BUP) as chain terminator, and 27.60 g (0.69 mol) of sodium hydroxide in 568.4 ml of water. Phosgene (47.47 g) (0.48 mol) is introduced at pH from 12.5 to 13.5 and 20° C. In order to prevent the pH from falling below 12.5, 30% strength sodium hydroxide solution was added during the phosgenation process. After phosgenation has been completed and the mixture has been flushed with nitrogen, stirring is continued for a further 5 minutes, and 0.411 ml (0.003 mol, 1 mol % based on bisphenols) of N-ethylpiperidine is then added as catalyst, and stirring is continued for a further hour. After the aqueous phase has been removed, the organic phase is acidified with phosphoric acid and washed with distilled water until neutral and salt-free. The organic phase is isolated and concentrated at 80° C. under the vacuum provided by a water pump, and dried to constant mass at 130° C. in the vacuum provided by a water pump.

This gives transparent polycarbonate.

### Example 3 (of the Invention)

### Synthesis of a copolycarbonate made of 2,2-bis(3-methyl-4-hydroxyphenyl)propane (3b) (“dimethylbisphenol A”) and bisphenol TMC

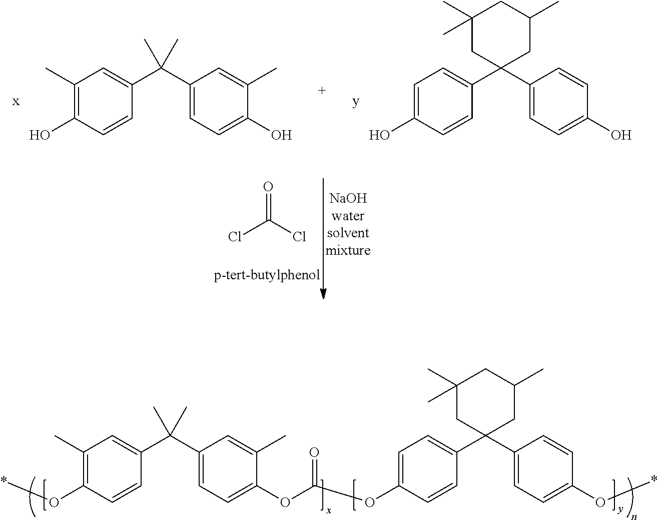

7.171 l of methylene chloride and 8.591 1 of chlorobenzene are added to a nitrogen-inertized solution of 1281.75 g (5.0 mol) of dimethylbisphenol A, 1552.1 g (5.0 mol) of bisphenol TMC, 57.08 g (0.380 mol, 3.8 mol % based on bisphenols) of p-tert-butylphenol (BUP) as chain terminator, and 929.29 g (23.00 mol) of sodium hydroxide in 15.763 l of water. Phosgene (1285.7 g) (13.0 mol) is introduced at pH from 12.5 to 13.5 and 20° C. In order to prevent the pH from falling below 12.5, 30% strength sodium hydroxide solution was added during the phosgenation process. After phosgenation has been completed and the mixture has been flushed with nitrogen, stirring is continued for a further 5 minutes, and 11.31 g (0.10 mol, 1 mol % based on bisphenols) of N-ethylpiperidine are then added as catalyst, and stirring is continued for a further hour. After the aqueous phase has been removed, the organic phase is acidified with phosphoric acid and washed with distilled water until neutral and salt-free. After the solvent has been replaced by chlorobenzene, the product is extruded at 270° C. through a vented extruder and pelletized through a pelletizer. This gives transparent polycarbonate pellets. The molar mass of the polycarbonate resin is Mn=8921 g/mol (number-average molar mass determined at room temperature by way of gel permeation chromatography GPC calibrated onto BPA polycarbonate with refractive index detector) and Mw=21 537 g/mol (weight average) with polydispersity D=2.41. Relative solution viscosity in methylene chloride (0.5 g/100 ml of solution) is 1.170.

### Example 4 (of the Invention)

### Synthesis of a copolycarbonate made of bisphenol A and 1,1-bis(3-methyl-4-hydroxyphenyl)-3,3,5-trimethylcyclohexane (3a) from example 1

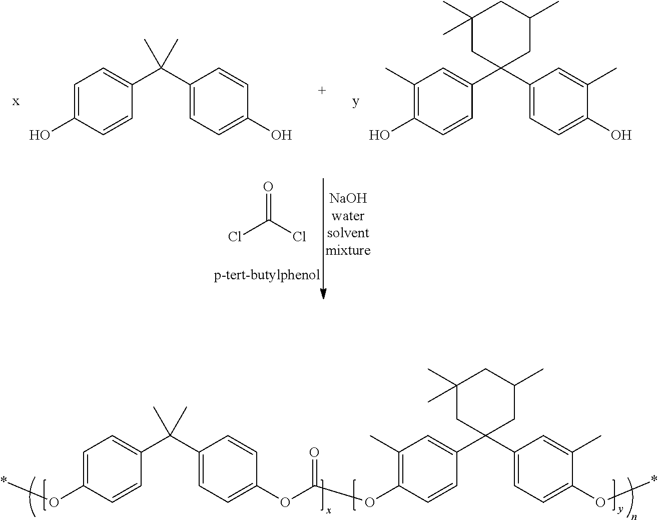

Sodium hydroxide (6.16 g) (0.154 mol) forms an initial charge and is dissolved in 306 g of water in an inertized phosgenation apparatus. The following are added to the solution: 11.19 g (0.05 mol) of bisphenol A (BPA) and 7.1058 g (0.021 mol) of dimethylTMC bisphenol from example 1. The solution made of 0.32 g (0.0021 mol, 3.0 mol % based on bisphenols) of p-tert-butylphenol (BUP) as chain terminator and 306 ml of methylene chloride is then added, and the mixture is stirred for 10 minutes at a moderate stirrer rotation rate. Phosgene (13.851 g) (0.14 mol) is introduced at pH from 12.5 to 13.5 and 20° C. In order to prevent the pH from falling below 12.5, concentrated sodium hydroxide solution was added during the phosgenation process. After phosgenation has been completed and the mixture has been flushed with nitrogen, stirring is continued for a further 5 minutes, and 0.096 ml (0.007 mol, 1 mol % based on bisphenols) of N-ethylpiperidine is then added as catalyst, and stirring is continued for a further hour. After the aqueous phase has been removed, the organic phase is acidified with phosphoric acid and washed with distilled water until neutral and salt-free. The organic phase is then dried over sodium sulfate and concentrated by evaporation overnight. The residue is then again dried at 80° C. for 8 hours under the vacuum provided by a water pump.

Relative solution viscosity is 1.218. Glass transition temperature was determined by means of DSC: 157° C.

### Example 5 (Comparative Example)

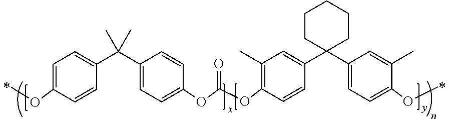

Lexan DMX 2415 from Sabic

| Tg [° C.] | 145° C. |
|---|---|
| ηᵣₑₗ | 1.235 |

### Example 6 (Comparative Example)

### Makrolon 2600 (aromatic, linear polycarbonate based on BPA from Bayer Materialscience AG)

### Example 7 (Comparative Example)

### APEC 2000 (aromatic, linear copolycarbonate based on bisphenol TMC and BPA from Bayer Materialscience AG)

### Example 8 (Comparative Example)

### Makrolon 3103 (aromatic, linear polycarbonate based on BPA from Bayer Materialscience AG)

### Example 9 (Comparative Example)

### APEC 1895 (aromatic, linear copolycarbonate based on bisphenol TMC and BPA from Bayer Materialscience AG)

Testing:

Testing of the Copolycarbonate from Example 4 Against an Ammoniacal Test Solution:

This test solution represents pharmaceutical active ingredients (for example intravenously introduced anesthetics, calcium antagonists, anticonvulsants, antiarrhythmics, calcineurin inhibitors for transplantation medicine, or in general terms lipid-containing emulsions), where these have aminic groups/NH functionalities in the molecule and come into contact with polymeric components in medical technology.

For the ammonia-resistance test, stepped plaques made of the polycarbonate with layer thickness 4 mm are completely immersed in an aqueous-ammoniacal solution (10% by weight). After each of various times (see table 1) of exposure to the test solution, a test specimen is removed and washed with water, and haze is measured after drying.

Haze is determined by way of wide-angle light scattering to ASTM D1003-00. The data are stated in % Haze (H), where low values represent low haze and are therefore desirable.

TABLE 1

| Time [h] | | | | | | | | |
|---|---|---|---|---|---|---|---|---|
| 0 | 2 | 4 | 5 | 6 | 7 | 24 | 48 | 72 |

Example 4

| | | | | | | | | |
|---|---|---|---|---|---|---|---|---|
| Haze | 3.27 | 2.1 | 2.55 | 1.78 | 1.45 | 11.9 | 56.8 | 81.4 |
| (%) | | | | | | | | |

Example 6

| | | | | | | | | | |
|---|---|---|---|---|---|---|---|---|---|
| Haze | 1.24 | 2.6 | 41.4 | 26.2 | 37.8 | 23.1 | 75.5 | 100 | 90.3 |
| (%) | | | | | | | | | |

Example 7

| | | | | | | | | | |
|---|---|---|---|---|---|---|---|---|---|
| Haze | 0.58 | 2.14 | 4.96 | 16.7 | 41.2 | 29.3 | 99 | 93.6 | 95.2 |
| (%) | | | | | | | | | |

In comparison with the comparative specimens, the optical measurements on the test moldings made of copolycarbonate of the invention reveal significantly increased stability in relation to haze after various times of exposure to the test solution.

Measurement of Surface Hardness:

The copolycarbonates are predried in a drying oven at 120° C. overnight. The polymers are then dissolved in methylene chloride and poured into small dishes of diameter 5 cm. The solvent was removed by evaporation, and the remaining polymer was then conditioned in a vacuum drying oven at 120° C. Removal of the polymer from the dish gives test disks of diameter 5 cm and thickness about 1-1.5 mm.

Surface hardness is measured on small plaques by means of an atomic force microscope AFM (Digital Instruments Nanoscope); the force used to impress a diamond stylus in a nanoindent-test head (Hysitron) into the surface of the polymer (80 μN), the stylus scan rate (1 Hz), and also the size of the measurement field (30×30 μm; scanned in 256 lines) are preset here, and in each case the volume removed mechanically from the surface of the specimen by the scanning process (depression in the material) is determined in μm³ as dependent variable which is therefore a unit of measurement for surface hardness. As this volume increases, the softness of the surface of the respective copolycarbonate material increases. Smaller volume values therefore indicate improved surface hardness. Table 2 lists values measured on copolycarbonates of the invention, and also on the comparative example.

TABLE 2

| | Example 5 | Example 4 |
|---|---|---|
| | (comparative example) | (of the invention) |
| Volume of depression | 57.4 | 38.0 |
| [μm³] | | |

The example of the invention of a copolycarbonate made of bisphenol TMC and dimethylBPA (example 4) reveals a significantly lower volume value here than for the comparative example (example 5). The surface hardness of the copolycarbonate of the invention has therefore been markedly improved in relation to the prior art.

Abrasion Test:

Wear resistance (abrasion) is determined by an abrasive-wheel method (DIN 53 754), by way of the increase in the amount of scattered light. Taber 5151 abrasion equipment was used, with CS-10F

Calibrase abrasive wheels (type IV), with an applied weight of 500 g per wheel. The haze values are measured after the number of cycles stated in table 3, and low values here mean good abrasion resistance.

TABLE 3

| | Example 8 | Example 4 | Example 9 |
|---|---|---|---|
| Taber cycles | Haze (%) | Haze (%) | Haze (%) |
| 0 | 0.4 | 0.4 | 0.4 |
| 10 | 16.0 | 12.5 | 14.1 |
| 25 | 23.3 | 19.8 | 23.8 |
| 50 | 25.7 | 23.7 | 26.5 |
| 75 | 27.5 | 25.4 | 27.1 |
| 100 | 27.9 | 26.0 | 28.2 |

In the Taber test, too, the copolycarbonate of the invention (example 4) is revealed as superior not only to the homopolycarbonate based on bisphenol A (example 8) but also to the copolycarbonate based on bisphenol A/bisphenol TMC.

1.-15. (canceled)

16. A copolycarbonate comprising a combination of diphenol compounds selected from
a) at least one compound from the group consisting of the compounds having the formula 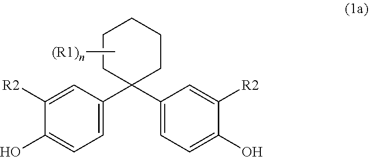
wherein the R1 moieties are, independently of one another, a C₁-C₄-alkyl,
n is 1, 2, or 3, and
the R2 moieties are, independently of one another, H, or a linear or branched C₁-C₁₀-alkyl, and
b) at least one compound from the group consisting of the compounds having the formula 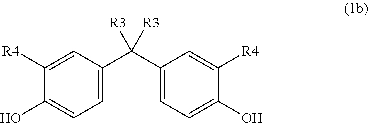
wherein the R3 moieties are, independently of one another, a linear or branched C₁-C₁₀-alkyl, and
the R4 moieties are, independently of one another, H or a linear or branched C₁-C₁₀-alkyl.

17. The copolycarbonate as claimed in claim 16, wherein the R1 moieties are, independently of one another, methyl, ethyl, n-propyl, isopropyl, or tert-butyl.

18. The copolycarbonate as claimed in claim 16, wherein the R2 moieties are, independently of one another, a linear or branched C₁-C₆-alkyl.

19. The copolycarbonate as claimed in claim 16, wherein the R2 moieties are, independently of one another, methyl, ethyl, n-propyl, isopropyl, or tert-butyl.

20. The copolycarbonate as claimed in claim 16, wherein the R3 moieties are, independently of one another, a linear or branched C₁-C₆-alkyl.

21. The copolycarbonate as claimed in claim 16, wherein the R4 moieties are, independently of one another, a linear or branched C₁-C₆-alkyl.

22. The copolycarbonate as claimed in claim 16, comprising from 0.1 to 80 mol % (based on the amount of diphenols used) of the diphenol selected from diphenols of formula (1a).

23. The copolycarbonate as claimed in claim 16, comprising from 5 to 75 mol % (based on the amount of diphenols used) of the diphenol selected from diphenols of formula (1a).

24. The copolycarbonate as claimed in claim 16, where the diphenols of the formula (1a) are diphenols of the general formula (2a).

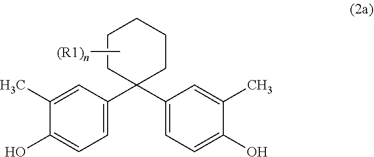

25. The copolycarbonate as claimed in claim 16, where the diphenols of the formula (1b) are diphenols of the general formula (2b).

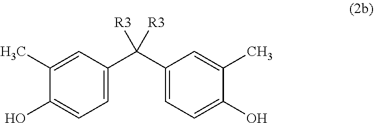

26. The copolycarbonate as claimed in claim 16, further comprising diphenols of the formula (5a) 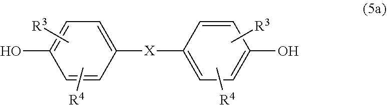
wherein
R³ and R⁴ are, independently of one another, hydrogen, C₁-C₁₈-alkyl, C₁-C₁₈-alkoxy, halogen, or optionally substituted aryl or aralkyl, and
X is a single bond, —SO₂—, —CO—, —O—, —S—, C₁- to C₆-alkylene, C₂- to C₅-alkylidene or C₅- to C₆-cycloalkylidene, which can have substitution by C₁- to C₆-alkyl, or X is a C₆-C₁₂-arylene which can optionally have been condensed with further aromatic rings comprising heteroatoms.

27. The copolycarbonate as claimed in claim 26, wherein the diphenol of the formula (5a) is 2,2-bis(4-hydroxyphenyl)propane (bisphenol A).

28. The copolycarbonate as claimed in claim 16, wherein the copolycarbonate has a solution viscosity ηᵣₑₗ of from 1.10 to 1.35.

29. A molding, extrudate, foil, or foil laminate, obtained from the copolycarbonates as claimed in claim 16.

30. An extrudate comprising one or more coextruded layers obtainable from copolycarbonates as claimed in claim 16.

31. A blend of the copolycarbonate as claimed in claim 16 with thermoplastic polymers.

32. A process for producing copolycarbonates as claimed in claim 16 by the interfacial process or melt transesterification process, which comprises using, as diphenols, a combination of compounds selected from one or more compounds of the formulae (1a) and from one or more compounds of the formulae (1b).

33. A card, a keyboard in electrical or electronic equipment, a lens, a screen/display cover, a portable multimedia device, a flat screen, a housing, housing part, or frame comprising moldings, extrudates, foils or foil laminates as claimed in claim 29.

34. An item for medical applications or products in medical technology comprising moldings, extrudates, foils, or foil laminates as claimed in claim 29.
